(19) United States
(12) Patent Application Publication
(10) Pub. No.: US 2009/0117304 A1
(43) Pub. Date: May 7, 2009

(54) Cover Ups

(75) Inventor: Kevin Elwood, Riverside, CA (US)

Correspondence Address: KEVIN ELWOOD, 3440 PROSPECT AVE., RIVERSIDE, CA, 92501, US

(73) Assignee: Kevin Elwood, Riverside, CA (US)

(21) Appl. No.: 11/277,511

(22) Filed: Mar. 26, 2006

(51) Int. Cl. B32B 33/00

(52) U.S. Cl. 428/40.1

(57) ABSTRACT

What is new about this product is it ability to bring humor to an embarrassing situation, while working to pre-treat the stain or spill. This invention is a simple combination of a sticker like material, with a pre-soaked pad attached. By sticking this patch to ones clothing, the pre-treated, pre-soaked pad will be in direct contact with the stain until removed. Hiding the stain and increasing the chance the stain will come out in the wash. Cover Ups should be removed before places clothes into the washing machine. Cover Ups can be proudly displayed with funny or meaningful text or pictures on the front. Or solid color matching Cover Ups can be used to discreetly hide the stain.

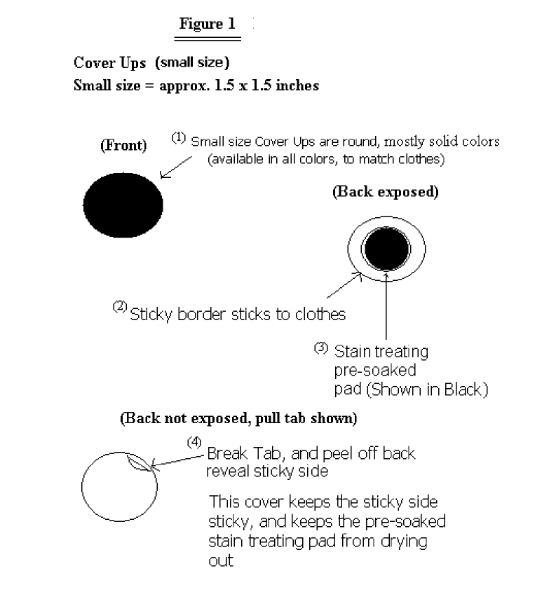

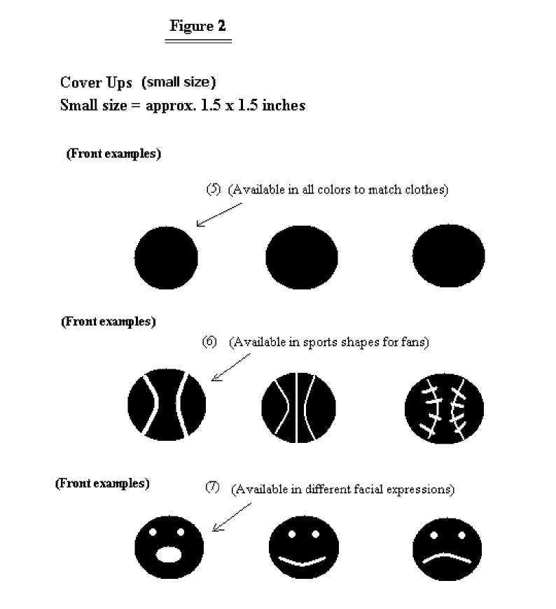

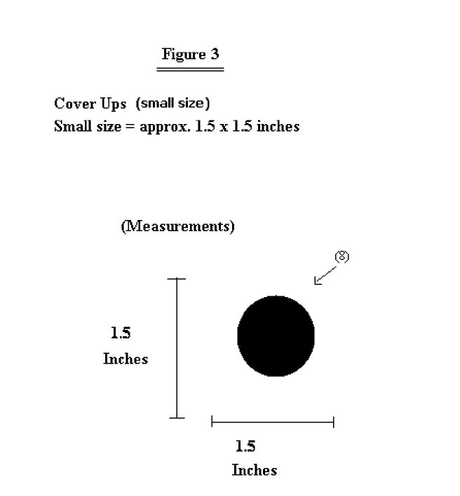

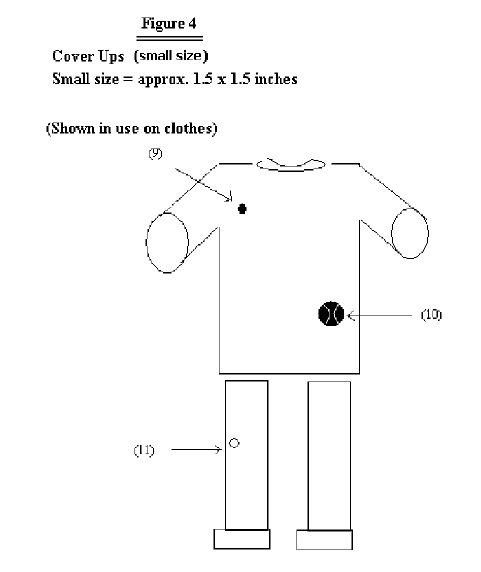

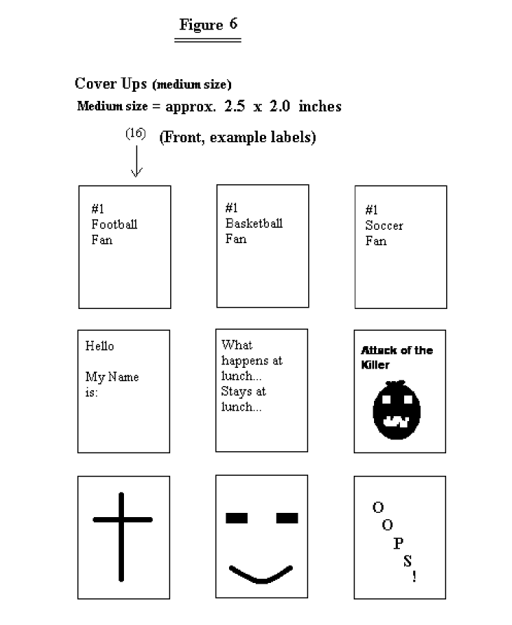

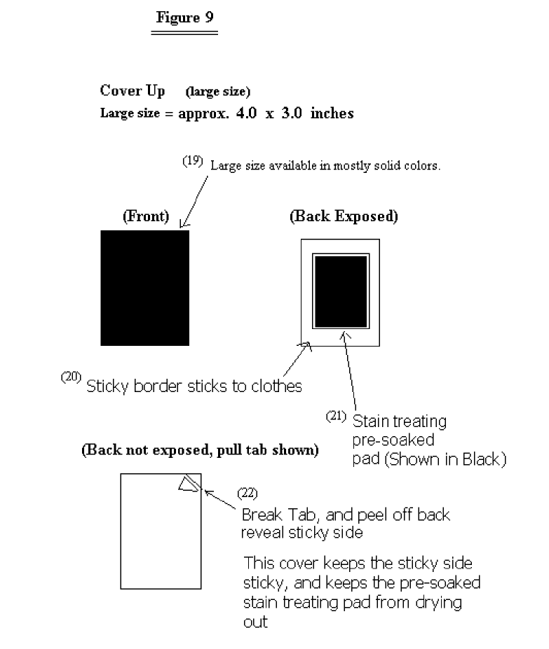

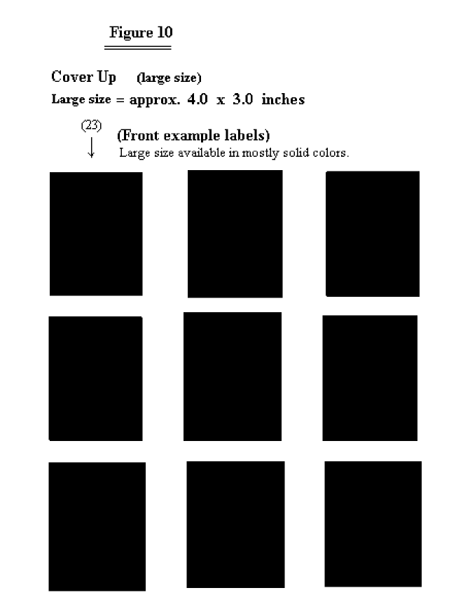

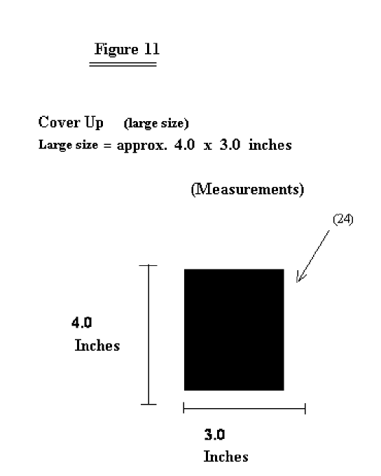

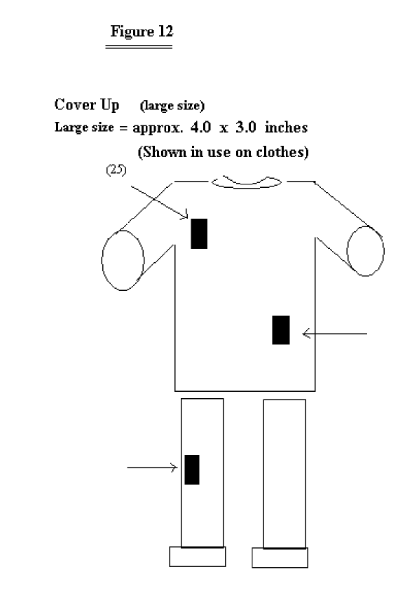

Cover Ups is made of a soft pliable material, leaving it free to bend and stick to clothing surfaces. Think of Cover Ups as a band-aide for hiding spills in the same way a band-aide hides cuts and scrapes. Think of a Cover Ups as a band-aide for preventing stains in the same way band-aide prevents infection. As shown in drawings FIGS. 1, 5 and 9 what a Cover Ups is, are small pre-treating patches designed to cover and treat stains while looking like decorative stickers. Drawings FIGS. 2, 6 and 10 shows how fun they can be, with limitless different styles, shapes, and sayings to choose from. Drawings FIGS. 3, 7 and 11 shows an example of the different sizes. They pre-treat the stains and help to prevent it from getting rubbed into the fabric any further. Disguised as a sticker no one will ever know you had a spill in the first place, all while helping to remove the stain later in the wash by pre-treating it as soon as it's applied, and continuing to treat it until removed prior to the wash. Drawings FIGS. 4, 8 and 12 show examples of use on clothing but are disguised as stickers. Weather to prevent embarrassment or to preserve clothing, the Cover Ups is a fun and convenient way for all age groups to deal with everyday spills, drips, smudges or whatever else life throws their way.

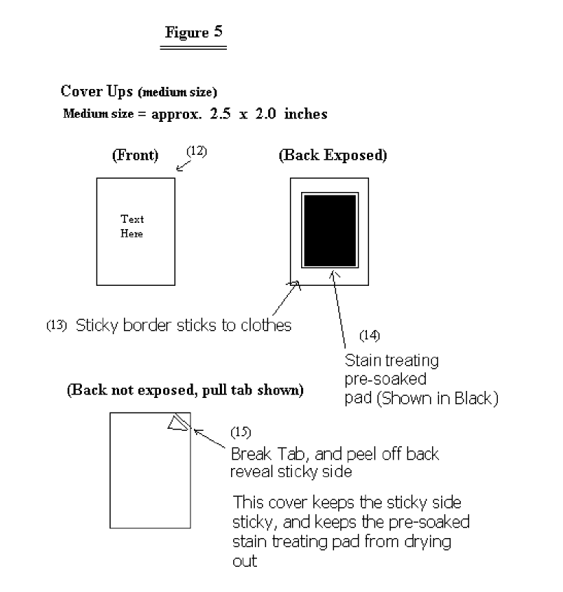

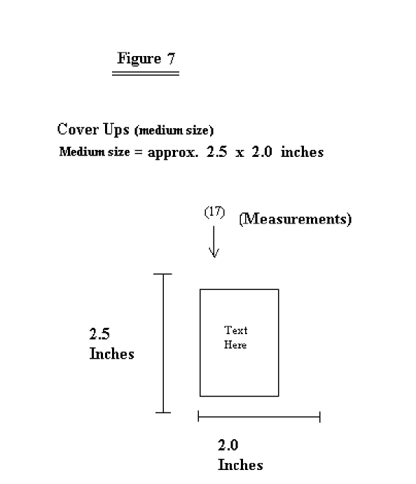

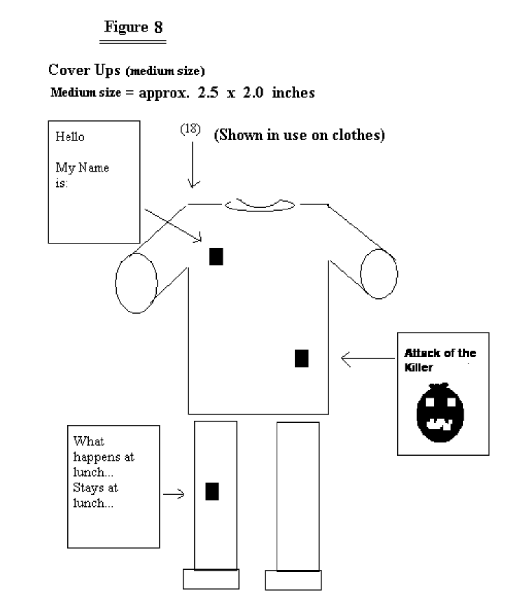

These patches will hide embarrassing stains and spills encountered during the day. Either by hiding the stain with a solid colored Cover Ups that matches clothes colors, or by using a Cover Ups that is more acceptable looking than a stain or spill as shown in FIGS. 1, 6, 7, 9, 10, 11, 12, 18, 23 and 25. Drawings FIG. 10 on page 4 has been enlarged to show sport design details. Drawings FIG. 11 is an example of a Cover Ups patch that's color matches the clothing to completely hide an embarrassing or unwanted stain or spill. These adhesive patches have sticky back border that sticks to clothes, drawings FIGS. 2, 13, and 20 and a stain treating pre-soaked pad on the back drawings FIGS. 3, 14 and 21. A peel back tab keeps back border sticky until ready for use and keeps Cover Ups from sticking together drawings FIGS. 4, 15 and 22. Pictures, jokes, or solid colors and other designs on the front drawing FIGS. 5, 16 and 19. Cover Ups come in three sizes, Small FIG. 8 Medium FIG. 17 and Large FIG. 24.

1. What is claimed is these patches will hide embarrassing stains and spills encountered during the day. Either by hiding the stain with a solid colored Cover Ups that matches clothes colors, or by using a Cover Ups that is more acceptable looking than a stain or spill (1) (6) (7) (9) (10) (11) (12) (18) (23) (25). Cover Ups is made of a soft pliable material, leaving it free to bend and stick to clothing surfaces. Think of Cover Ups as a band-aide for hiding spills in the same way a band-aide hides cuts and scrapes. Think of a Cover Ups as a band-aide for preventing stains in the same way band-aide prevents infection. Number (10) on page 4 has been enlarged to show sport design details. Number (11) is an example of a Cover Ups patch that's color matches the clothing to completely hide an embarrassing or unwanted stain or spill. These adhesive patches have sticky back border that sticks to clothes (2) (13) (20) and a stain treating pre-soaked pad on the back (3) (14) (21). A peel back tab keeps back border sticky until ready for use and keeps Cover Ups from sticking together (4) (15) (22). Pictures, jokes, or solid colors and other designs on the front (5) (16) (19). Cover Ups come in three sizes, Small (8) Medium (17) and Large (24)
